(19) United States
(12) Patent Application Publication
(10) Pub. No.: US 2023/0047543 A1
(43) Pub. Date: Feb. 16, 2023

(54) DRIED PRODUCTS MADE FROM FRUIT AND/OR VEGETABLES AND PRODUCTION METHODS

(71) Applicant: PASONA KNOWLEDGE PARTNER INC., Osaka (JP)

(72) Inventors: Peter Eisner, Freising (DE); Dominic Wimmer, Muenchen (DE); Christian Zacherl, Muenchen (DE); Regina Lightner (nee Fischl), Muenchen (DE)

(21) Appl. No.: 17/975,014

(22) Filed: Oct. 27, 2022

Related U.S. Application Data
(62) Division of application No. 15/580,251, filed on Dec. 6, 2017, now abandoned.

(30) Foreign Application Priority Data
Jun. 15, 2015 (DE) 102015210890.2

(51) Int. Cl. A23L 19/00; A23B 7/024; A23B 7/01; A23B 7/02

(52) U.S. Cl. CPC A23L 19/09; A23B 7/024; A23B 7/01; A23B 7/02; A23V 2300/31; A23L 33/21

(57) ABSTRACT

The dried products of the present invention provide snacks (so-called crispy smoothies) having a particularly high proportion of fruit, which, owing to their production at low temperatures with extensive exclusion of oxygen, are distinguished by a high level of preservation of oxidation- and temperature-sensitive, but valuable, fruit constituents and which have an intense flavor and also a homogeneous appearance which is attractive in terms of color.

### CROSS-REFERENCE TO RELATED APPLICATIONS

This application is a divisional of U.S. application Ser. No. 15/580,251, filed Dec. 6, 2017, which is a National Stage Application under 35 U.S.C. § 371 and claims the benefit of International Application No. PCT/EP2016/063699, filed Jun. 15, 2016, which claims priority to DE 10 2015 210 890.2, filed Jun. 15, 2015. The disclosures of the foregoing applications are hereby incorporated by reference in its entirety.

### TECHNICAL FIELD OF APPLICATION

The present invention relates to plant-based dried products made from fruit and/or vegetables, more particularly fruit and vegetable snacks, having a firm and crispy texture and to methods for producing said dried products.

### STATE OF THE ART

Snack products are widespread in the area of processed foods. Examples of popular snacks are potato chips or cornmeal extrudates, which in many cases are admixed with salt, flavorings or, in the case of extruded snacks, with peanut butter for example. Fruit and vegetable snacks include especially dried fruit and vegetable pieces such as apple or pineapple slices or even entire dried fruits such as, for example, raisins, figs, dates, prunes or other dried fruit and vegetables.

The aforementioned products vary quite considerably with respect to their color and texture. Whereas chips or peanut flips are characterized by a crispy texture, the texture of most dried fruit and vegetable snacks is more soft or gummy, meaning that many of the dried products are not consumed by the consumers as typical crispy snacks. Especially in the case of dried fruit such as apples or raisins, the color and the flavor of the fruits moreover change quite considerably during the drying process as a result of oxidation, reducing the enjoyment of the products.

To increase crispiness, some dried products such as banana or pineapple pieces are provided with sugar and/or deep-fried in order to achieve a firmer and crispy texture. However, at the same time, the value added to said products in terms of acoustics and firmer bite is offset by the addition of sugar or oil, meaning that the natural composition of the fruits is no longer present in the end product. A similar situation applies to the use of antioxidants. For example, addition of sulfite or ascorbic acid during the drying of fruits and vegetables can minimize browning and preserve the color of the products, but such additives are undesired for many consumers.

A distinct improvement in color and crispiness can be achieved through the use of vacuum methods. Examples thereof are the freeze-drying (e.g., CN102342318), the microwave vacuum drying (e.g., CN101849573) or the puffing (EP2408322 B1) of fruits and vegetables. In said methods, the water content of the dried products is reduced in a vacuum to values below 10% by mass and a crispy texture is thus obtained. Owing to the extensive exclusion of oxygen during the drying, the color and flavor preservation of the end products are also distinctly superior to those of conventional dried products.

A further approach for producing fruit-based snacks having a crispy texture is described in WO201411813. Said approach is based on mixing a fruit material with a binding material, with the mixture subsequently being subjected to cooking and dehydrogenation steps until a desired proportion of water and also in the mixture and a desired bubble structure is achieved. However, the use of the binding material reduces the proportion of fruit in the snack product, and this can also have a disadvantageous effect on the flavor of the fruit snack.

However, the aforementioned products also exhibit disadvantages which are due to the raw material in the majority of cases. For instance, most fruits and vegetables vary quite considerably with respect to sweetness, acidity, flavor, color and oxidation stability. This is especially the case among different species and varieties, but also for the same varieties depending on the location, climate or harvest year. Consequently, the quality parameters sweetness, acidity and color of the end products vary quite considerably in the absence of addition of antioxidants, sugar or acid. From experience, considerable differences can be registered even among individual fruits of the same harvest or within one fruit (e.g., red and green areas of the very same strawberries), which differences are perceived by the consumers as natural variation, but usually also as disadvantageous. Therefore, according to the prior art, a uniform color, sweetness or acidity of the end products cannot be achieved without the use of granulated sugar or other food additives.

It is an object of the present invention to provide dried products made from fruit and/or vegetables, more particularly as fruit and/or vegetable snacks, which have a crispy texture and, even without the addition of granulated sugar or food additives, turn out distinctly more consistent in the description of the quality parameters sweetness, acidity, flavor consistency and color than the known dried products from the prior art.

### DESCRIPTION OF THE INVENTION

The object is achieved by the dried products and the methods for the production thereof according to the independent claims. Advantageous embodiments of the dried product and of the production method are subject matter of the dependent claims or can be gathered from the following description and the exemplary embodiment. Furthermore, uses of the herein-described dried products are claimed.

A herein-proposed dried product made from fruit and/or vegetables can be formed from dried fruit- and/or vegetable-containing pieces having a water content of below 7% by mass and is distinguished by the fact that the dried fruit- and/or vegetable-containing pieces contain constituents of more than one fruit or vegetable variety or of at least one fruit variety and at least one vegetable variety or of different fruits or plants of the same fruit or vegetable variety.

The terms fruit and vegetables are used here in the customary form. Fruit is an umbrella term for the fruits or parts thereof (e.g., seeds) which are edible in a raw state for humans and usually water-containing and which originate from trees, shrubs and perennial plants. Typical species groups of fruit are pomes, drupes, berries, nuts, classic tropical/subtropical fruits and also further exotic fruits. Vegetables is an umbrella term for edible plant parts of plants which grow in the wild or are cultivated. They are usually leaves, fruits, tubers, stems or roots of annual or biennial herbaceous plants. Dry seeds such as peas or lentils and grains are not counted as vegetables. The term variety also covers strains, since strains represent varieties of various properties with regard to appearance, content and properties concerning ripening, storage and use.

Constituents of a fruit or vegetable variety, or fruit or vegetable constituents, can comprise, for example, the juice or flesh or else the entire fruit or vegetable.

In a further aspect, there is proposed herein a method for producing crispy dried products made from fruit (FIG. 1), which method uses highly comminuted constituents of at least one fruit variety as starting material. Application of the method according to the invention allows processing at low temperatures with extensive exclusion of oxygen, meaning that dried products can form which are distinguished by a high proportion of fruit, a high preservation of oxidation- and temperature-sensitive, but valuable, fruit constituents, a homogeneous color distribution, a crispy texture and an intense flavor.

Depending on the embodiment, the present invention can exhibit a multitude of advantages and technical effects. Comminution and homogenization of fruit constituents allows the use of fruit, the external appearance of which would no longer be sufficiently appealing for the retail industry. As a result, there is, firstly, no need for specific selection of the starting materials; secondly, costs can be reduced. At the same time, comminution and homogenization also lead to homogenization of properties with respect to taste and color in the herein-described dried product. Furthermore, comminution allows more variable or more homogeneous shaping, while the process conditions, for example in the predrying or in the microwave drying (puffing), have a more uniform effect on the homogenized mass composed of fruit constituents. Thus, it is possible overall to minimize losses and to utilize available foodstuffs more efficiently.

The method according to the invention allows the use of a broad spectrum of starting materials to which the method conditions can be individually adapted, though gentle temperatures and oxidation with conditions minimizing atmospheric oxygen are always possible such that not only valuable protein and lipid constituents, but also vitamins and other secondary plant metabolites are preserved to a great extent. Besides these nutritional physiology advantages, the dried products according to the invention are also additionally appealing with respect to color and pleasantly crispy, while they are distinctly more favorable than, for example, freeze-dried entire fruits or large fruit pieces.

Furthermore, the production of dried products according to the invention does not require the addition of binders. In the herein-described method, the sugar endogenous to the fruit can suffice in order to maintain a sufficiently cohesive mass during the various drying steps and to ultimately obtain a dried product of crispy consistency. In the case of dried products according to the invention, it is possible to use either a fruit strain or fruit variety as starting material or a mixture of multiple fruit strains or fruit varieties. In the case of embodiments also containing vegetables, a fruit variety must always be added to a mixture in order to ensure a sufficient sugar content in the mixture, meaning that a cohesive mass forms which can be further processed without addition of binders.

Although the addition of binders is not required for the production of the proposed dried products, it is possible to add to the comminuted and puréed mass protein material which is of high value in terms of nutritional physiology, but which does not act as functional binding material owing to lack of interaction with comminuted mass composed of fruit constituents. For example, this can be achieved by addition of particulate protein particles which do not dissolve or only slightly dissolve (<10% by mass of the protein) in the surrounding mass and thus do not increase the firmness of the dried products. Addition of fruit juice to the comminuted starting material or to or onto the surface of an already predried mass can contribute to an enrichment of vitamins, prevention of color reactions of the plant-endogenous polyphenols with oxygen, or to flavor and color optimization.

These and further technical effects and advantages of the invention will be more particularly elucidated below on the basis of the figures and examples.

### LIST OF FIGURES

FIG. 1: Flow chart of a method for producing crispy dried products.

FIG. 2: Water and sugar content of different raw materials.

FIG. 3: Differing lightness of dried products made from banana with and without exclusion of oxygen.

FIG. 4: Appearance of a whirled product and of a marbled product.

FIG. 5: Layered dried product made from banana and mango in side view and in top view.

FIG. 6: Coconut flakes covered by banana purée.

FIG. 7: Expansion factors of different dried products.

FIG. 8: Color values of yellow dried products.

FIG. 9: Color values of red dried products.

FIG. 10: Color distribution on the surface of a conventionally dried banana and of a dried product according to the invention made from banana.

FIG. 11: Color distribution on the surface of a conventionally dried pineapple and of a dried product according to the invention made from pineapple.

FIG. 12: Standard deviations of lightness and color values of dried products according to the invention in comparison with conventional products.

FIG. 13: Scanning electron micrographs of cross sections of conventionally dried pineapple and of a dried product according to the invention made from pineapple.

FIG. 14: Scanning electron micrographs of longitudinal sections of conventionally dried pineapple and of a dried product according to the invention made from pineapple.

FIG. 15: Scanning electron micrographs of a cross section and of a longitudinal section of a dried product according to the invention made from pineapple and banana.

FIG. 16: Scanning electron micrographs of cross sections of conventionally dried banana and of a dried product according to the invention made from banana.

FIG. 17: Scanning electron micrographs of longitudinal sections of conventionally dried banana and of a dried product according to the invention made from banana.

FIG. 18: Texture analysis of dried products according to the invention.

FIG. 19: Intruded mercury volume plotted against the pore diameter for selected dried products according to the invention.

FIG. 20: Pore size distribution curve for selected dried products according to the invention.

FIG. 21: Average pore diameters for selected dried products according to the invention.

### DETAILED DESCRIPTION OF THE INVENTION

The individual steps of the methods and properties of the dried products of the present invention will be described in detail below.

In the proposed method, it is possible for fruit and/or vegetable constituents of different varieties or harvests or constituents of different fruits or plants of the same variety or harvest to be blended to form a moist or liquid mass or a moist or liquid mixture and for the mass or the mixture to be subsequently dried. In this connection, the mass or the mixture can be formed or be treated before and/or after the drying such that dried fruit- and/or vegetable-containing pieces are obtained as dried product.

Provision

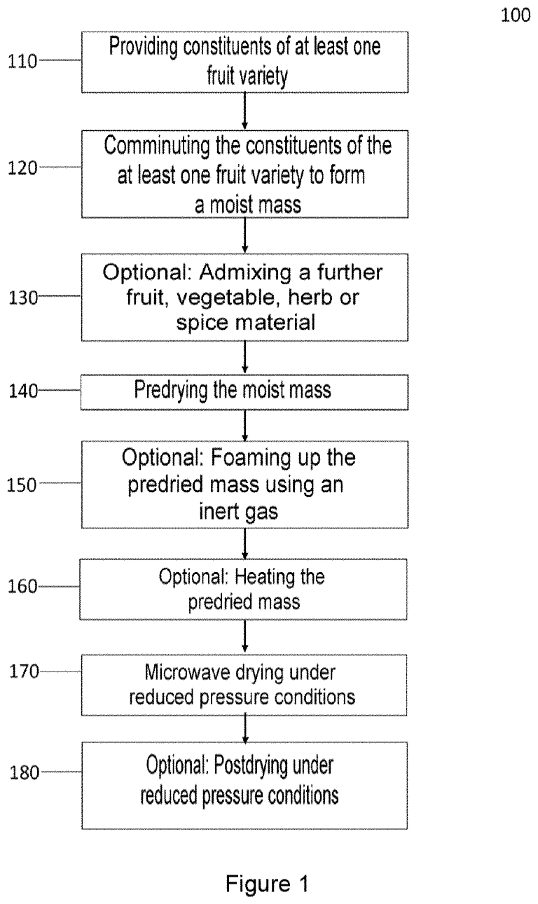

Providing constituents of at least one fruit variety as starting material is a first step in the herein-described method for producing a dried product according to the invention (step 110 in FIG. 1).

For this purpose, it is possible to use fruit varieties of various degrees of ripeness. The use of fruit with a high degree of ripeness can contribute to more crispy and more flavorful dried products. This can allow the use of fruit with such a high degree of ripeness that would otherwise no longer be suitable for sale. For example, this applies to bananas, during the ripening of which the starch is mainly degraded into the low-molecular-weight sugars such as sucrose and ultimately into fructose and glucose.

Even when mixing various raw materials, it is possible to advantageously use fruit with a high degree of ripeness. For example, through the blending of bananas and strawberries, the pureeing of various fruits or vegetables to a desired consistency and viscosity or through further mixing variations, it is possible to balance differing contents of sugar, acid, color intensity and oxidation stability of the individual fruits or vegetables in a particular way and to thus standardize the quality parameters of the end products.

The water content of the raw materials might have a crucial influence on the structure and crispiness of the dried product, since it has an effect on pore formation, pore size and pore distribution. For example, the input of air and the stabilization of air bubbles during the microwave drying or puffing might be associated with the viscosity of the puréed starting material. For example, in the case of certain fruit varieties, a withdrawal of water before comminution might have a positive influence on pore formation during the microwave drying or puffing and on the crispiness of the product.

To withdraw water from fruits, they can, for example, be subjected to a relatively long storage time. However, it is also possible to use fruits with a high degree of ripeness, the water content of which has already decreased. Alternatively, it is possible to use various methods for a specific withdrawal of water. For example, it is possible to use different drying methods such as convection drying (e.g., cabinet drying, fluidized bed drying, baking oven or similar methods), contact drying (contacting the mass with a heated solid, metal sheet, belt or the like) or evaporation (e.g., rotary evaporator or similar methods). An oxygen-reduced or oxygen-free gas phase is advantageously used during the drying.

Depending on the fruit variety used, it may for example be favorable in the production of the dried products to reduce the water content in the raw material to about 60-85% (e.g., to 65-80% or to 70-75%) before the fruit constituents are comminuted by an input of mechanical energy and optionally subjected to an input of gas. A water content reduced in this way may also have an advantageous effect on the shapeability and the shape stability of the mass. It may also be advantageous to contact the fruits with an oxygen-free or oxygen-reduced atmosphere for a certain period of time prior to the processing in order to reduce the proportion of oxygen dissolved in the fruit prior to the processing.

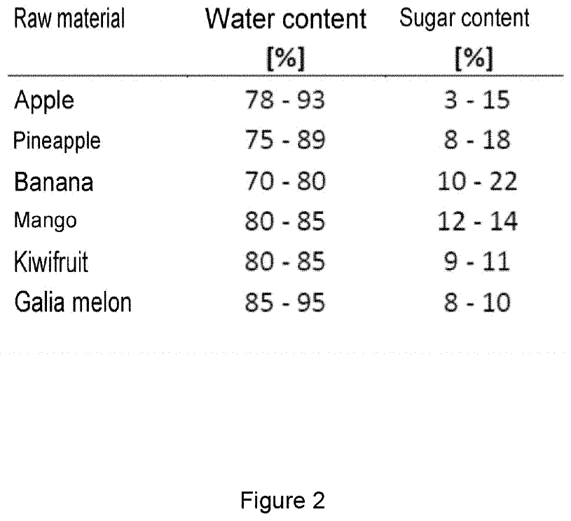

FIG. 2 shows by way of example the water content and the sugar content of fruit varieties which, owing to these properties, are suitable for the herein-described processing to yield dried products according to the invention. A multitude of further fruit varieties has comparable properties and is therefore just as well suited for processing to yield the herein-described dried products according to the herein-described methods.

For example, it is possible to use the following fruit varieties alone or in any desired combination to produce the herein-described dried products: pineapple, chokeberry, banana, date, strawberry, goji berry, raspberry, blueberry, blackberry, kiwifruit, melon, fig, peach, apricot, grape, physalis, currant, grapefruit, orange, lime, lemon, coconut, pear, acerola, mandarin, cherimoya, dragon fruit, pomegranate, guava, rosehip, cherry, lychee, mango, passion fruit, mirabelle, plum, cranberry, sea buckthorn, quince, gooseberry, acai, elderberry, papaya, or lucuma.

Comminution

Depending on the at least one fruit variety used and on the drying method, it is possible, as described herein, by means of mechanical comminution to produce a native moist mass (step 120 in FIG. 1) which can be further processed in subsequent method steps to yield a dried product having desired properties in terms of texture and flavor. Depending on the degree of comminution, the proportion of intact cells can vary. The proportion of intact cells of the herein-described dried products is, as a result of the comminution, reduced in comparison with conventional fruit or vegetable snacks made from entire fruits or large fruit pieces. Upon comminution, the proportion of intact cells can be reduced to less than 90% (e.g., less than 80%, less than 70%, less than 60% or less than 50%) of the intact cells of the provided constituents of the at least one fruit variety.

The constituents of the at least one fruit variety can be comminuted using different instruments. Crushing or mortar-and-pestle action is possible too. For example, it is possible to use cutting mills, rollers, mixers, cutters, mortar and pestles, or colloid mills. The comminution yields a moist mass which can have the consistency of a purée. The moist mass (e.g., the purée) can be varied in terms of its viscosity by appropriate selection of the degree of comminution.

Since some of the cellular and other protective structures of the constituents of the at least one fruit variety are broken up during the comminution process, it may be advantageous to reduce the presence of atmospheric oxygen during the comminution process. This can, for example, prevent oxidation reactions of polyphenols, which can lead to considerable color changes in some fruit species such as, for example, bananas or apples. The exclusion of oxygen makes it possible to largely preserve the native color of the fruit constituents in the resulting dried products, whereas the color of products processed in the presence of oxygen becomes darker and browner. Furthermore, the absence of atmospheric oxygen can protect against vitamin loss (e.g., vitamin C). During the comminution, the partial pressure of oxygen can be reduced to less than 100 mbar (e.g., less than 90 mbar or less than 70 mbar or less than 50 mbar). It has been found to be advantageous to reduce the partial pressure of oxygen during the comminution to less than 50 mbar (e.g., to 45 mbar, 40 mbar or 35 mbar). It may be particularly advantageous to reduce the partial pressure of oxygen to less than 30 mbar (e.g., to 25 mbar, 20 mbar or less). A possible alternative to the exclusion of oxygen is to add acidic fruit juice to the moist mass or to coat the moist mass with fruit juice, the result being that an undesired discoloration can likewise be reduced. Furthermore, it is possible to combine a reduction in the partial pressure of oxygen with the addition of acidic fruit juice.

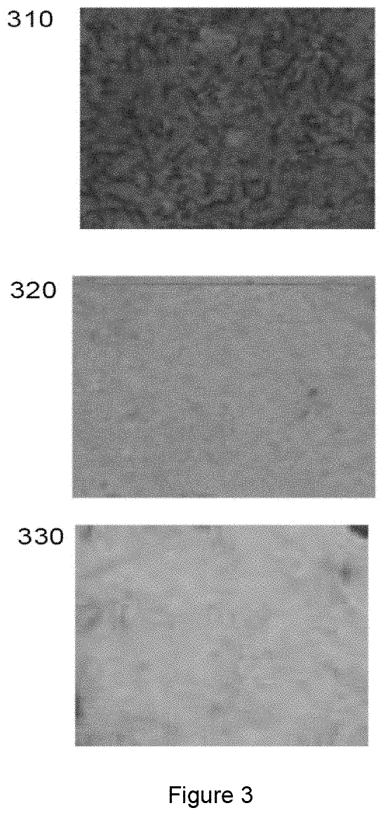

FIG. 3 shows this using the example of a dried product made from comminuted banana, involving spreading out puréed banana on a metal sheet and then predrying it. Picture 310 shows the darkly discolored surface of a dried product made from comminuted banana which was processed in the presence of atmospheric oxygen. Picture 320 shows the lighter surface of a dried product made from banana which was comminuted with flushing of nitrogen and the surface of which was sprayed with lemon juice prior to the predrying. 330 shows the even lighter interior of a dried product made from banana which was comminuted with flushing of nitrogen and the surface of which was sprayed with lemon juice prior to the predrying. Without committing to any theory relating to the mechanistic principles, the treatment of the surface with acid appears to inactivate the polyphenol oxidase which initiates the browning reaction with oxygen, as can be seen on picture 320 in comparison with picture 310. As can be seen on picture 330, the oxygen appears to be displaced from the moist mass as a result of the prior comminution with flushing of nitrogen. Moreover, it was not possible as a result for oxygen to penetrate through the surface into moist mass.

Although the degree of comminution does not appear to have any considerable influence on properties of the herein-described dried products such as crispiness, texture, volume increase (expansion) or flavor, the degree of comminution can be selected depending on the starting material such that the dried product exhibits the aforementioned properties in a desired manner.

However, the degree of comminution can influence the viscosity and the gas proportion of the moist mass. For example, a strong comminution of bananas with the aid of a colloid mill leads to a higher viscosity of banana purées and to an increased input of gas from the surrounding atmosphere. A higher viscosity might, in turn, have a positive effect on the shapeability (e.g., injectable) of a purée, since air bubbles, which lead to a larger volume and a more crispy texture of the products, may possibly be maintained in the microwave drying or puffing to a higher degree. In addition, relatively fine purées can be mixed with relatively coarse fruit pieces after the comminution.

Mixing

The herein-described dried products can be produced from constituents of at least one fruit variety. However, it is also optionally possible to mix constituents of two or more fruit varieties (e.g., of 3, 4, 5 or more fruit varieties) (step 130 in FIG. 1). Optionally, it is also possible to admix vegetables, herbs or seeds in comminuted or uncomminuted form. In this connection, the purée or the crude mass can be produced by comminution of the intended mixture or the individual components can be comminuted separately and then brought together as moist masses. As a result, different shapes and colors are possible depending on the fruit varieties mixed.

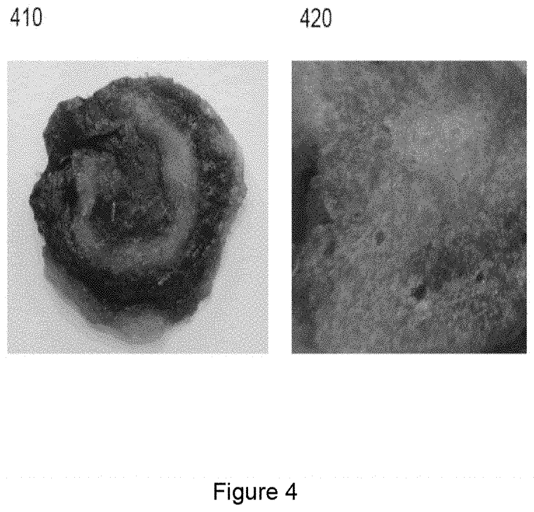

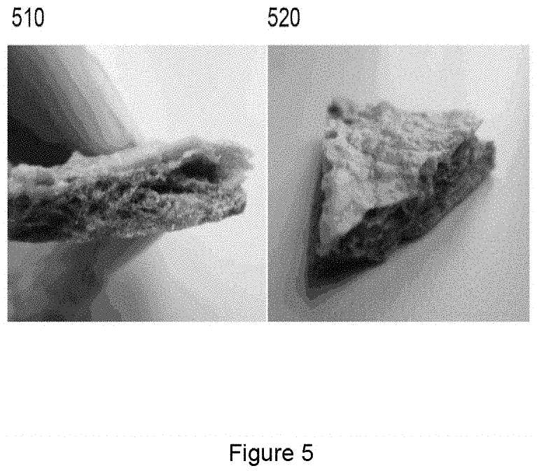

FIGS. 4 and 5 show by way of example how the color properties of the herein-described dried products can be specifically set through appropriate mixing or layering of different fruits. FIG. 4 shows the spiral lines of a whirled dried product (picture 410) and a marbled dried product (picture 420) made from pineapple purée and strawberry purée in each case. Proceeding from the herein-described comminution, it is possible to generate dried products having a layer structure. In FIG. 5, this is shown using the example of a dried product made from banana and mango. Picture 510 shows a lateral view of a dried product made from banana and mango, with a thin and light upper layer being formed from comminuted mango and a thicker and darker lower layer being formed from comminuted banana. Picture 520 shows a perspective top view of such a dried product made from banana and mango. Furthermore, the content of atmospheric oxygen during comminution of different constituents can be adjusted such that desired color contrasts can be set in layered dried products.

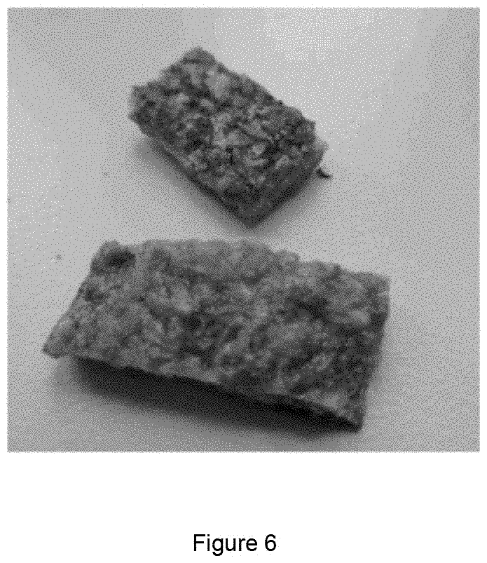

The herein-described steps for comminution, to varying degrees as desired, allow, in conjunction with a subsequent mixing step, a multitude of possible combinations. In addition, less comminuted constituents of a further vegetable variety, for examples pieces or slices, can be introduced as filler into an already puréed moist mass. For example, as shown in FIG. 6, coconut flakes can be covered by banana purée. Furthermore, pieces can also be sprinkled with juice, allowing an enrichment with additional flavors and valuable ingredients. Furthermore, it is also possible for entire fruit pieces to be covered with a puréed moist mass.

It is possible to obtain dried products according to the invention that are advantageous in terms of taste when the proportion of comminuted constituents of the at least one fruit variety in the dried product is more than 80% by mass (e.g., 81%, 82%, 83%, 84%, 85%, 86%, 87%, 88%, 89%, 90%, 91%, 92%, 93%, 94%, 95%, 96%, 97%, 98%, 99% or 100%).

Furthermore, it is possible to obtain dried products according to the invention that are advantageous in terms of taste when a filtered or partially filtered juice from the at least one fruit variety, from another fruit variety or from multiple fruit varieties is added to a moist mass composed of comminuted constituents of the at least one fruit variety. The fruit juice proportion by mass of the moist mass can be 25% or less (e.g., 24%, 23%, 22%, 21%, 20%, 19%, 18%, 17%, 16%, 15%, 14%, 13%, 12%, 11%, 10%, 9%, 8%, 7%, 6%, 5%, 4%, 3% or less).

With respect to the mixing of different raw materials, a multitude of variations is possible. Different raw materials are understood here to mean either different fruit/vegetable varieties or species or simply just different fruits or plants of the same harvest, or fruits/vegetables of different harvests, varieties or species or respectively fruit/vegetable constituents thereof. This means that mixtures consisting only of bananas of one harvest or different harvests are just as possible as mixtures composed of various fruit/vegetable varieties or species, as are known nowadays as smoothies for example. Mixtures composed of plants or fruits of the same harvest, for example of bananas of different degrees of ripeness, are possible too.

Some methods for combining and mixing or blending the raw materials are described below by way of example:
Blending different raw materials to form a mash, a pasty mass or a mixture containing pieces.
Blending different raw materials to form a liquid mixture, for example by pureeing, stirring or kneading. Blending different raw materials to form a juice mixture or juice-like mash or purée.
Mixing juices or juice concentrates from different raw materials.
Sprinkling fruit or vegetable pieces with juice or concentrate of other fruits, plants or vegetables, which can also originate from the same species, variety or harvest as the fruits/vegetables of the fruit or vegetable pieces.

Particularly advantageously, the mixing or blending of the individual raw materials is also carried out under a reduced oxygen atmosphere in order to minimize the oxidation of the raw materials. For this purpose, it is possible to process the raw materials under vacuum or under a protective-gas atmosphere (e.g., nitrogen). If necessary, this processing can also be combined with storage of the raw materials with extensive exclusion of oxygen.

If, after the blending of the different raw materials or of a raw material in differing degree of comminution, the original shape of the fruit and/or vegetable varieties or the constituents thereof is altered, it is possible to take measures after the mixing process in order to reacquire from the mixture individual portions which can be transferred to a dry, crispy form. This can be achieved through simple portioning before the drying, for example into appropriate shapes such as hearts, stars, flowers, circles, triangles, squares or the like.

As described herein, the at least one comminuted fruit variety of the dried products according to the invention can be mixed with a multitude of vegetable varieties, herbs, spices or seeds individually or in combination and in variable degrees of comminution.

Various vegetable varieties can be used in the herein-described dried products. Examples of these include: avocado, pumpkin, carrot, tomato, zucchini, onion, garlic, curcuma, beetroot, potato, pepper, spinach, corn, artichoke, eggplant, cucumber, radish, leek, yam, cauliflower, broccoli, red cabbage, white cabbage, snap peas, fresh peas, beans, fennel, ginger, kohlrabi, parsnips, rhubarb, Brussel sprout, black salsify, celery, Chinese cabbage, mache, rocket, chard, chicory, kale, lettuce, iceberg lettuce, maca, sprouts and germ buds (e.g., cress, soybean sprouts), mushrooms, chili peppers or olives.

As described herein, herbs can also be used in the dried products of the present invention. Examples of these include: parsley, basil, chives, dill, oregano, rosemary, marjoram, lovage, sage, ramson, savory, borage, stinging nettle, tarragon, chervil, coriander, mint or woodruff.

Spices, too, can be used individually or in combination in the dried products according to the invention. Examples of these include: curry, curcuma, ginger, cinnamon, capsicum powder, garlic powder, caraway, pepper, salt, chili powder, cumin, cardamon, coriander seed, nutmeg, orange peel, lemon peel or saffron.

Furthermore, it is also possible to use different kernels or seeds in the herein-described dried products, such as, for example: linseeds, chia seeds, sesame, hempseeds, psyllium seeds, sunflower seeds, poppy seeds, pumpkin seeds, pine kernels, cumin seeds, fennel seeds, aniseeds, fenugreek seed or mustard seed.

Lastly, further additives in relation to the dried products according to the invention are possible for coloration, taste optimization or for increasing certain ingredients such as polyphenols, vitamins or minerals. Examples of these include: algae (Chlorella, Spirulina), dried leaves (matcha, green tea, black tea), vanilla, wheatgrass, barley grass, moringa or cacao nibs.

Predrying

In the context of the method step for the predrying (140 in FIG. 1), various methods suitable for drying are possible in principle. Examples include vacuum methods such as freeze-drying, microwave drying/puffing or other methods which are suitable for the production of crispy and largely anhydrous products. Preferably, the predrying can be carried out under a continuous stream of nitrogen, argon or carbon dioxide, since this has a positive effect on the preservation of color of the product.

Predrying may prove advantageous in the production of dried products according to the invention made from comminuted or puréed moist masses, as described herein. Firstly, the predrying serves to produce cohesive masses for better shaping, which masses, however, must still contain a certain amount of water for a further microwave vacuum expansion. The water present in the moist mass can then be stimulated by the microwave used under reduced pressure conditions, it being possible for the predried mass to be inflated or expanded by means of the evaporation process getting under way. During a postdrying process taking place afterwards, sugar constituents can crystallize or solidify amorphously to form a stable and brittle structure.

In this connection, it may prove advantageous when comminuted constituents of at least one fruit variety are concentrated to a water content of 35-60% (e.g., to 40%, 45%, 50% or 55%) in an evaporation or drying unit closed off from the surroundings, preference being given to largely excluding contact with atmospheric oxygen. This can take place either in a closed evaporator or dryer which is operated at pressures distinctly below atmospheric pressure (vacuum) and/or is filled or flushed with nitrogen. During the predrying, the partial pressure of oxygen can be reduced to less than 100 mbar (e.g., less than 90 mbar, less than 70 mbar or less than 50 mbar). It proves advantageous to reduce the partial pressure of oxygen during the predrying to less than 50 mbar (e.g., 45 mbar, 40 mbar or 35 mbar). It may be particularly advantageous to reduce the partial pressure of oxygen to less than 30 mbar (e.g., 25 mbar or 20 mbar or less).

Furthermore, it is advantageous when temperatures higher than 80° C. are prevented from occurring in the moist mass. During the predrying, the temperature in the moist mass can, for example, be held below 70° C., advantageously below 60° C. and particularly advantageously below 50° C. The combination of reduced temperature during the drying and oxygen exclusion makes it possible to preserve many of the constituents of fruits that are important in terms of nutritional physiology (vitamins, antioxidants, etc.).

The moisture required in the predried mass for microwave drying under reduced pressure conditions can be between 30 and 60%, preferably between 35 and 50%, depending on the product and on the desired pore size in order to generate a puffed mass having the desired crispiness and texture. The water content of the predried mass can, for example, be reduced to a proportion by mass of 60%, 55%, 50%, 45%, 40%, 35% or 30%.

Foam-Up

Optionally, a predried mass can be foamed up using an inert gas (step 150 in FIG. 1). Thus, with respect to the volume, the crispiness and the consumption acoustics of the dried products, it may be found that foam-up of the predried mass, which still contains 30-60% water, using gas or vapor leads to a disproportionately better volume increase in microwave drying under reduced pressure conditions. In this connection, even a proportion of 10-30% by volume (e.g., 15%, 20%, 25% or 30%) of gas or vapor bubbles in the moist mass can, depending on the raw material, lead to the volume of the dried products after the expansion or puff-up by microwave drying being greater by a factor of 2-5 times (e.g., 2, 3, 4 or 5 times) than the volume of the predried mass before the puff-up by microwave drying. Depending on the amount of inert gas used for the foam-up, distinctly larger expansion factors are also possible. For example, an expansion by a factor of 5-10 is possible.

Moreover, the input of gas or foam can increase the crispiness and reduce the hardness of the final products, and this in turn can have a positive effect on consumption experience. However, the proportion of gas or vapor in the predried mass should also not be chosen at too high a level, so that the firmness of the products and a noticeable resistance when chewing is preserved (crispiness). For instance, in the case of an input of gas into the predried mass, a value of 80% by volume of gas in the mass should not be exceeded; preferably, the value of the proportion of gas should be between 5-50% by volume (e.g., 45%, 40%, 35%, 30%, 25%, 20%, 15% or 10%).

The input of foam can be carried out in different ways. For example, nitrogen or another inert gas can be blown into the moist mass at a water content>60% or else even during the drying. However, nitrogen which is situated above the mass can also be inputted into the moist mass by stirring or other mechanical agitation by means of dispersers or rapidly running blades. Furthermore, the input of foam or gas can be integrated into the fruit comminution process before the predrying. However, in the latter case, it should be ensured that the foam does not completely escape from the mass again during the predrying. This can be achieved by use or addition of raw materials which strongly tend to foam during evaporation, such as bananas for example.

Microwave Drying

In the context of the herein-described method for producing a dried product, microwave drying (step 170 in FIG. 1) can be carried out under various conditions. Of particular importance in this connection are the applied vacuum or the reduced pressure conditions, the temperature, the duration of the procedure, and the intensity of the microwave radiation. These can be chosen such that, depending on the constituents used, the dried product subsequently has desired properties regarding volume, crispiness, texture, flavor, etc.

Desirable properties for a herein-described dried product can, for example, be achieved at temperatures of less than 80° C., preferably less than 70° C., particularly preferably at temperatures of less than 60° C. (e.g., 55° C., 50° C. or less). With respect to the vacuum, advantageous results for dried products according to the invention are achieved at reduced pressure conditions of below 100 mbar (e.g., of 90 mbar, 80 mbar, 70 mbar, 60 mbar). Particularly advantageous dried products are observed at reduced pressure conditions of less than 50 mbar (e.g., at 40 mbar, 30 mbar, 20 mbar or less). The duration of the microwave drying is within the range of a few minutes. Depending on the temperature and reduced pressure conditions, the duration of the microwave drying can be 3-15 minutes (e.g., 4, 5, 6, 7, 8, 9, 10, 11, 12 or 14 minutes). The intensity of the microwave radiation can be between about 10 and 30 W*g⁻¹. In principle, the parameters pressure, temperature, duration, and microwave radiation intensity can be varied in a mutually dependent manner such that a dried product having desirable properties is obtained.

Following the microwave drying, the thus obtained expanded or puffed mass can be subjected to a relatively long, gentle postdrying (FIG. 1, step 180). In the case of dried products according to the invention, postdrying can usually be carried out at temperatures of 35-60° C. (e.g., at 40, 45, 50 or 55° C.). Depending on the temperature and pressure, the postdrying can last up to 6 hours (e.g., 1, 1.5, 2, 2.5, 3, 3.5, 4, 4.5, 5 or 5.5 hours). The postdrying is preferably carried out under reduced pressure conditions similar to those of the microwave drying.

Optionally, the predried and possibly foamed-up mass can be heated before starting the microwave drying (step 160 in FIG. 1) in order to further improve the properties of the herein-described dried products. A positive influence has been found in the case of heating to 40-50° C. (e.g., 42, 44, 46 or 48° C.) for a period of 3-15 minutes (e.g., 4, 5, 6, 7, 8, 9, 10, 11, 12 or 14 minutes).

The expansion ratio can be used as a quantitative variable for the quality of the microwave drying. This can be calculated using the formula below:

Expansion=(V₂/V₁)*100% Formula (1)

Here, V₁ is the volume of the sample before the microwave drying and V₂ is the volume after the microwave drying. The expansion is primarily dependent on the fruit and/or vegetable varieties used, the proportion of gas or foam, and the water content of the sample during the microwave drying. If too little water is present in a predried mass (<30%), insufficient expansion by means of microwave drying under reduced pressure conditions may take place. An excessively high amount of water in a moist and predried mass (>60%) similarly has a negative effect on the expansion by means of microwave drying under reduced pressure conditions, since the predried mass still has too little solid structure in order to be able to withstand the stretching of the mass due to the evaporating water. A light skin supports the stretching of the mass and the postdrying can stabilize the shape.

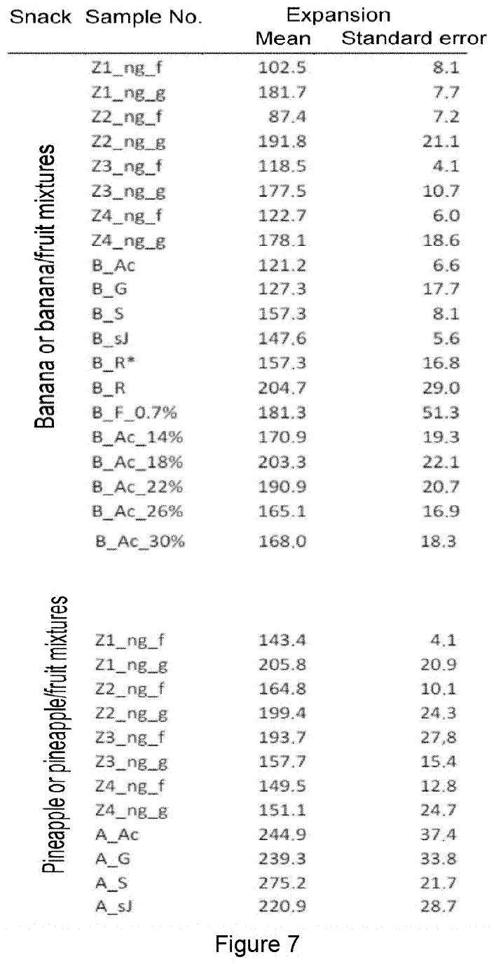

Depending on the starting materials used, expansion factors can be between 87% and 275% or more (e.g., at 90%, 100%, 110%, 120%, 130%, 140%, 150%, 160%, 170%, 180%, 190%, 200%, 210%, 220%, 230%, 240%, 250%, 260%, 270%). After prior introduction of inert gas, this value can be additionally exceeded depending on the proportion by volume of gas. Particularly crispy textures are observed when a volume of the dried product according to the invention is 150% or more of a volume of the predried mass, i.e., has expansion factors of about 150% or more of the predried mass. FIG. 7 is a table showing the expansion factors of various dried products produced according to the herein-described methods. The selected base substance was either banana or pineapple. Both were each mixed with other fruit varieties and produced using various conditions in the individual method steps.

Shape and Appearance

Shape and appearance of dried products produced according to the herein-described methods can be designed in a variety of ways.

To obtain pieces at the end of the processing, which pieces can be consumed as a bite-sized portion or can be further processed as, for example, cereal additive, it is advantageous to clear the mass of water before the final drying to such an extent that it can be portioned. This is particularly helpful when the mass no longer has a sufficiently firm consistency. For instance, a mash, a purée or a juice mixture can be evaporated or predried until the appearance of a firm consistency. Once the resulting concentrated mass has assumed a pasty or semisolid consistency, it can be brought into a defined shape and then, through this uniform shape, subjected more easily to uniform drying. Differing water contents in individual pieces of a production batch, as are known from the drying of individual fruits, can thus be avoided.

To further solidify the consistency of the mass, the addition of further ingredients for texturizing or for water binding is also possible. In this case, it is, for example, possible to use dried ground fruits/vegetables, flours from plant-based raw materials such as grains, legumes, oilseeds or the like. The addition of press residues from the drinks industry, fiber preparations or proteins is conceivable too for solidifying the consistency of the mass before the drying. Besides the stabilization of the mass before the drying, the addition of the stated ingredients to the mass before the drying also offers the possibility of altering the texture of the dried end products and of making the firmness, the acoustics and the bite of the dried products more attractive for the consumers. Especially when using proteins, press residues and insoluble fibers, this can be varied easily.

Besides the direct use of the dried products according to the invention as fruit and/or vegetable snacks, it is also possible to process the dried products to form further products such as cereal additive, cereal bar, additive for granola yoghurts, salad croutons, powder or granulate for producing drinks, chocolate filler, praline filling, sausage filler, baking additives, for preparing teas, as decoration for different applications, etc.

To dry the mass particularly uniformly, it may also be advantageous to produce uniform rods, sausages or other geometric shapes having a uniform and constant surface/volume ratio from the mass and to dry them up to a defined water content. After this drying step, these relatively large pieces can then be easily cut up into bite-sized portions using mechanical cutting units and, optionally, be postdried thereafter in a second drying step, if this is still necessary in order to achieve a water content of below 10% by mass.

The processing of the mass before the complete drying up to a crispy consistency has the advantage that it is possible, in comparison with the hitherto drying of entire fruits or fruit pieces, to produce dried products in defined shapes (e.g., in the shape of a heart, cube, star or animal). The shaping before the drying has the positive effect that there is no pulverulent dust which would arise in the shaping of the completely dried products.

Shape

To achieve a desired portioning of the herein-described dried products, various approaches are possible. For example, a moist mass composed of comminuted constituents of at least one fruit variety can be filled into frames and be predried to form cuttable plates or sheets so that they can then be cut into strips, cubes or other geometries of desired size. Cuttable sheets or plates can be provided in differing layer thickness. A layer thickness can be preferably between 3 and 15 mm (e.g., 4 mm, 5 mm, 6 mm, 7 mm, 8 mm, 9 mm, 10 mm, 11 mm, 12 mm, 13 mm or 14 mm). Depending on the use of the dried product, the layer thickness can be less than 3 mm (e.g., 2.5 mm, 2 mm, 1.5 mm, 1 mm, 0.5 mm or less). The layer thickness can also be above 15 mm (e.g., 16 mm, 17 mm, 18 mm, 19 mm, 20 mm, 21 mm, 22 mm, 23 mm, 24 mm, 25 mm). The portioning of the dried product according to the invention can be chosen such that it is suitable for the intended use (e.g., as snack product, cereal additive, cereal bar, additive for granola yoghurts, salad crouton, powder, granulate for producing drinks, chocolate filler, praline filling, sausage filler, or baking additive).

Alternatively, dried products to be produced can also be portioned and shaped using a dough piping bag or pastry press. In this case, a certain viscosity is required in order to keep the desired shaping stable for further processing steps. An injectable mass of sufficient viscosity can, as described herein, be ensured through use of fruit having a high content of dried substance (e.g., banana), through the pre-evaporation of water, the addition of predried fruits or the degree of comminution. Furthermore, it is also possible to use extrusion technology or pastry machines for a desired portioning. Lastly, it is also possible to use 3D printing methods in order to achieve a desired portioning and shape for the dried products according to the invention. The portioning can, again, be chosen such that the dried product according to the invention is suitable for the intended use. This can be achieved through simple portioning before the drying, for example into appropriate shapes such as hearts, stars, flowers, circles, triangles, squares or the like.

Color

The dried products produced according to the herein-described method can be single-colored or multicolored. By combining constituents of different fruit varieties and with avoidance of color changes due to oxidation, various color combinations are possible through the fruit-endogenous colorings. These can go from a very light yellow (e.g., when using pure banana as starting material) up to very dark hues (red, green, blue). By mixing fruit varieties, it is possible to achieve further shades.

Herein-described dried products can be characterized in terms of their color by means of L*a*b* color measurement. Here, the L* value is the lightness coordinate and the values a* and b* appear as color axes. The value of the L* axis extends from 0 (black) to 100 (white). The red-green axis is represented here by the a* value. Here, negative values are the green color portion and the positive values are the red portion. The b* value by contrast characterizes the shades blue and yellow. Negative values symbolize the blue color spectrum and positive values are distinguished by the yellow portion.

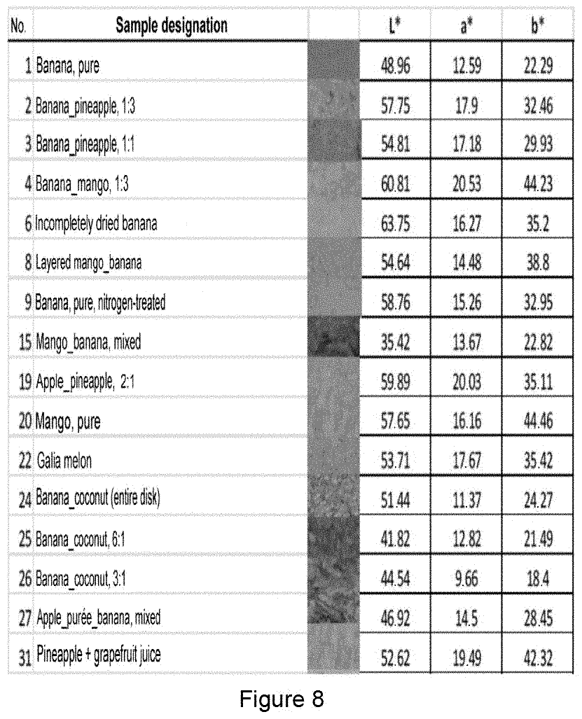

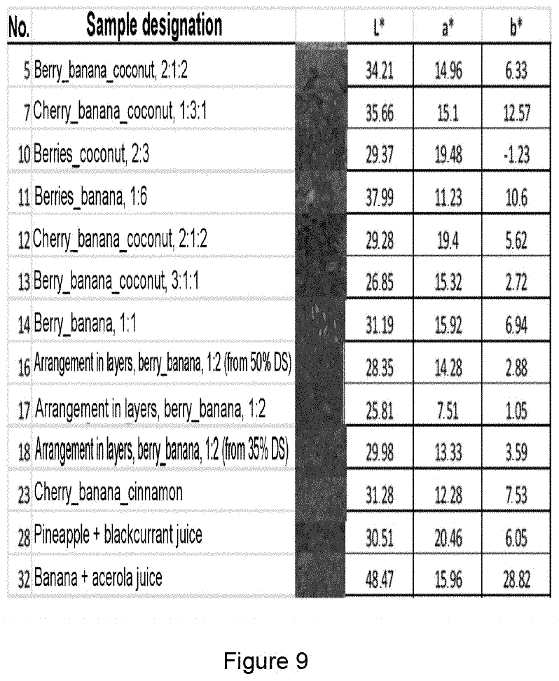

FIG. 8 shows the results of L*a*b* color measurements for dried products according to the invention which mainly contain yellow fruits, such as, for example, banana, pineapple or mango, as starting materials. An assessment of the individual samples by standard observer shows that L* values of above 50 (e.g., 55, 60, 65, 70 or more) and b* values of at least 20 yield light to luminous yellow hues which can be very attractive. FIG. 9 shows results of L*a*b* color measurements for dried products according to the invention which contain a red fruit variety, such as, for example, cherry, strawberry, raspberry, blackberry or blackcurrant, or a red fruit juice from such a fruit variety.

Homogeneity

A particular distinguishing feature in relation to conventional fruit snacks consisting of entire fruit pieces is the homogeneity of the color in dried products according to the invention. However, this is only the case when seed- or stone-containing fruits are not used or the seeds/stones/nutlets are removed beforehand or very finely comminuted (e.g., the stones from raspberry or nutlets of strawberries).

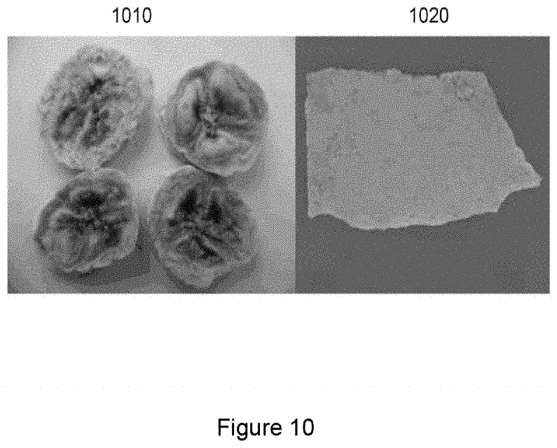

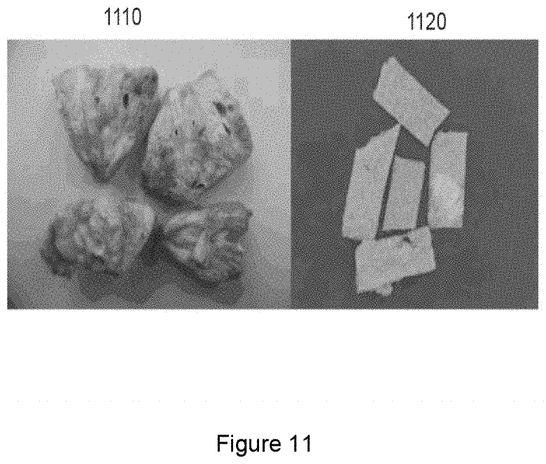

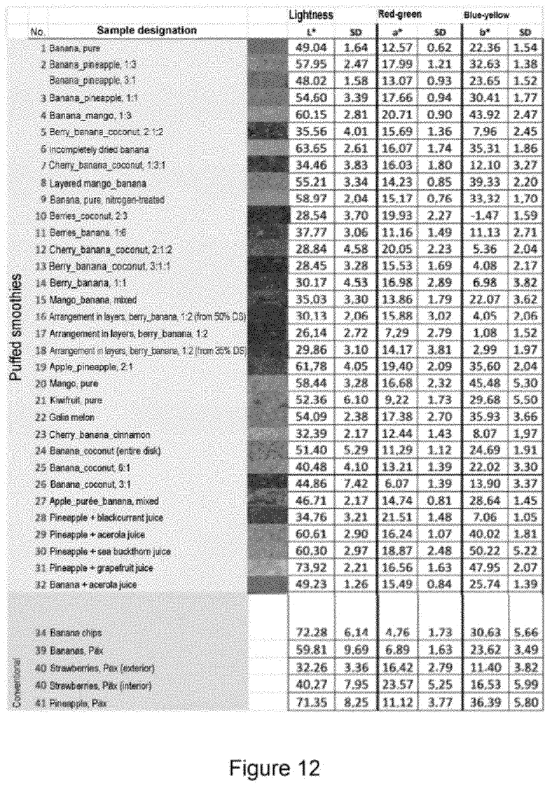

As shown in FIGS. 10 and 11, dried products according to the invention are more homogeneous in color and lightness than conventionally dried fruits. FIG. 10 shows this by way of example for the color distribution on the surface of a conventionally dried banana (picture 1010) in comparison with a dried product according to the invention made from banana (picture 1020). FIG. 11 shows more homogeneous color distribution on the surface of a dried product according to the invention made from pineapple (picture 1120) compared to a conventionally dried pineapple (picture 1110). Owing to the homogeneous comminution and mixing of different parts of the fruit, the dried products of this invention have a more homogeneous appearance, which can also be confirmed in the L*a*b* color values and the standard deviations (SDs) determined therefrom in the table in FIG. 12.

For instance, the table in FIG. 12 shows, in the majority of cases, a standard deviation of less than 5 for the lightness of dried products according to the invention. This also applies to the majority of dried products containing more than one fruit variety. However, if the fruit constituents have been insufficiently comminuted, as for example in the case of sample 21, which contains kiwifruit together with its black seeds, or sample 26, which contains white coconut flakes in dark banana mass, the standard deviations within a sample may also turn out higher in the case of dried products according to the invention. In general, however, it is the case that the homogeneous matrix of dried products according to the invention, into which seeds, nutlets or other fruit pieces have been introduced during comminution or mixing, exhibit a higher degree of homogeneity in comparison with conventional fruit snacks made from individual large fruit pieces or fruit slices. For example, dried products according to the invention which contain seeds, nut pieces or other fruit pieces show a standard deviation of 10 or less (e.g., 9, 8, 7 or 6) with regard to the lightness over the surface of the dried product. Particularly preferred dried products according to the present invention have standard deviations of 5 or less (e.g., 4, 3 or 2) for the lightness of a surface.

Character, Organization and Structure

Characteristic of the dried products according to the invention made from comminuted constituents of fruit and/or vegetable varieties are the organization and the structure. Whereas in conventional snacks made from entire dried fruits the organization of the cells is preserved to a great extent and clearly discernible in micrographs, the herein-described dried products made from comminuted constituents are organized differently depending on the raw material used. However, the original cell structure is in most cases no longer clearly discernible (depending on the degree of comminution).

Scanning electron micrographs make clear the structural differences between commercial puffed fruit snacks made from entire fruit pieces and dried products according to the invention.

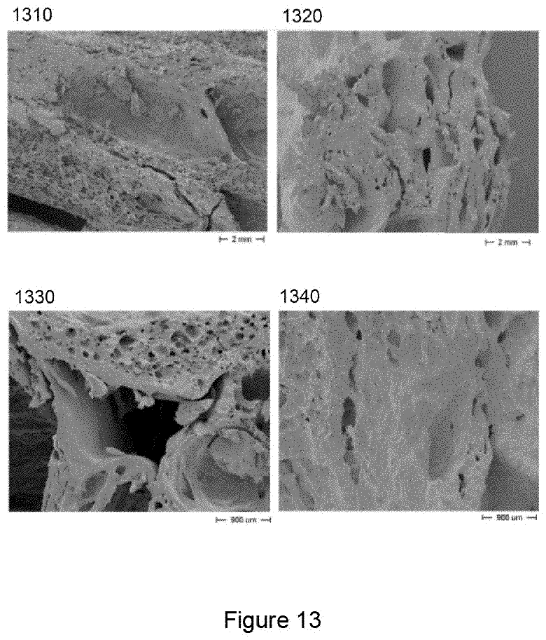

FIG. 13 shows a comparison of scanning electron images of cross sections of a conventional, commercially available snack made from largely intact pineapple pieces with a dried product according to the invention based on puréed pineapple. On pictures 1310 and 1330, it is possible to discern that the cellular structure appears to be virtually completely preserved in the case of entire puffed fruits. Here, crystallized or amorphously solidifying sugar appears to have deposited on the intact cell walls and to stabilize surrounding regions filled with air. The corresponding pictures 1320 and 1340 of cross sections of the dried product according to the invention made from pineapple, by contrast, show a distinctly lower number of intact cells with a simultaneous increase in disordered air pockets. With increasing degree of comminution of the starting materials, a reduction in the number of intact cells can be fundamentally observed. Nevertheless, air pockets are also present in the images of the dried product according to the invention made from pineapple, which air pockets are also in this case presumably stabilized by crystallized sugar.

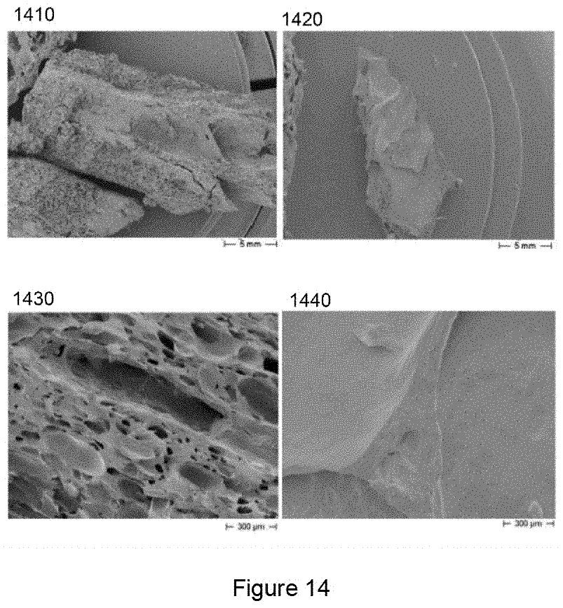

FIG. 14 shows a comparison of scanning electron images of longitudinal sections of a conventional, commercially available snack made from largely intact pineapple pieces with a dried product according to the invention based on puréed pineapple. Like images of the cross sections, those of the longitudinal sections also show distinct differences. On pictures 1410 and 1430, it is again possible to discern that the cell structures are well preserved in the commercial product. In contrast, pictures 1420 and 1440 of the dried product according to the invention show layered, sheet-type structures. Presumably, the sugar solidified/crystallized here in a layered manner during the drying.

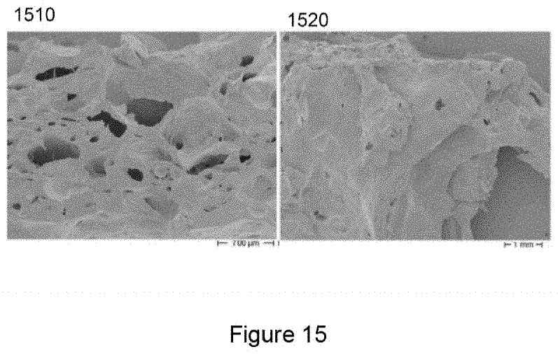

FIG. 15 shows scanning electron micrographs of a longitudinal section and of a cross section of a dried product according to the invention based on a mixture of banana and pineapple in a 1:3 ratio. The image of cross section 1510 makes it clear, as already for the dried product according to the invention made from pineapple of FIGS. 13 and 14, that the number of intact cellular structures is reduced, whereas the number of disordered air pockets appears increased. In the longitudinal section, picture 1520, are again the layered, sheet-type surface for the dried product according to the invention made from a mixture of banana and pineapple.

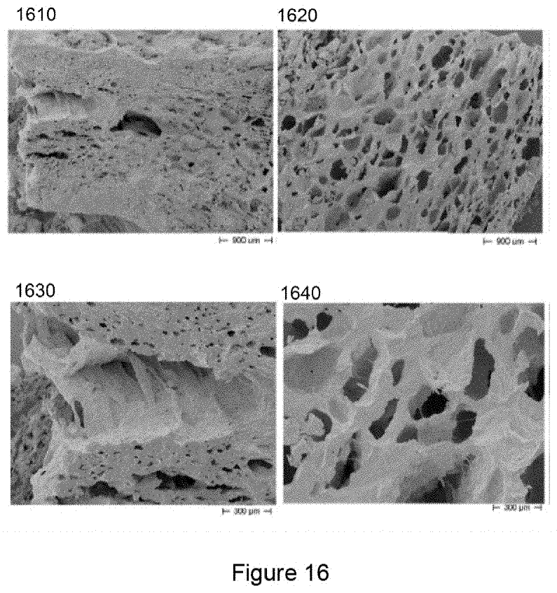

FIG. 16 shows a comparison of scanning electron images of cross sections of a conventional, commercially available snack made from largely intact banana slices with a dried product according to the invention based on puréed banana. On pictures 1610 and 1630, the commercial snack (puffed snack made from entire bananas) appears to have a more fibrous structure. Thus, longitudinally oriented, long and fibrous bundles, among which the cavities are embedded, are seen on scanning electron micrographs 1610 and 1630. By comparison, pictures 1620 and 1640 of the dried products according to the invention show pores having a comparatively large volume in a relatively regular arrangement. This may possibly be explained by the fact that air or gas pockets might have been largely preserved during the predrying or the microwave drying as a result of crystallization of fruit sugar.

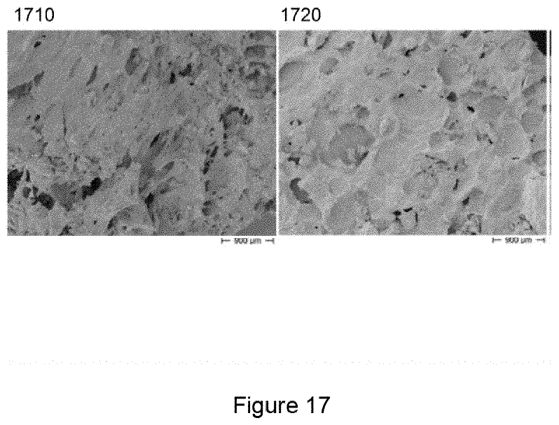

FIG. 17 shows a comparison of scanning electron images of a longitudinal section of a conventional snack made from largely intact banana slices with a dried product according to the invention made from banana. For the commercial snack, picture 1710 shows an oriented fibrous structure in the longitudinal section too. As can be seen in picture 1720, the dried product according to the invention made from banana is organized in a more crater-type manner in the longitudinal section, but also has smooth surfaces which again might have arisen through the layered crystallization of sugar.

If, in scanning electron micrographs, the structures of dried products according to the invention made from pure pineapple (FIGS. 13 and 14) or predominantly pineapple (FIG. 15) are compared with the structures of dried products according to the invention produced from pure banana (FIG. 16), the dried product based on pure banana shows a more pore-rich, but also more ordered structure than the pineapple-based dried products according to the invention.

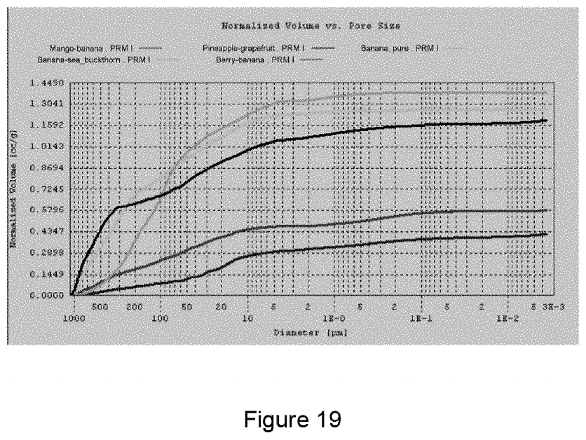

In summary, it can thus be stated in relation to structure that the crispiness in the case of commercial puffed snacks made from entire fruits is effected more through the preserved cells and the solidification/crystallization of the sugars on the cell walls. The resultant gas-filled cavities are responsible for the crispy impression. By contrast, these cavities or pores in the case of the dried products according to the invention may presumably arise more randomly and are therefore more disordered (as in the case of the dried product made from puréed pineapple). Alternatively, the cavities or pores may possibly be inputted by a relatively high initial dry mass in the comminution, fixed by the relatively high viscosity of the fruit constituents comminuted to form a purée, and crystallized/solidified during the drying process (as for example in the case of the dried product made from puréed banana). Independently of how the pores or cavities are formed, dried products according to the invention are characterized by average pore diameters of from 15 to 400 micrometers (μm) (FIGS. 19-21), as can be determined by mercury porosimetry. Depending on the degree of comminution of the at least one fruit variety and of further constituents of the mass, it is possible to observe in dried products according to the invention average pore diameters of, for example, 20 μm, 25 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, 300 μm, 310 μm, 320 μm, 330 μm, 340 μm, 350 μm, 360 μm, 370 μm, 380 μm or 390 μm by means of mercury porosimetry.

Furthermore, in the dried products according to the invention, it is regularly possible to discern a more or less strongly pronounced layer formation and thus a higher homogeneity.

Water Content and Texture

In the case of the dried product, it proves advantageous to reduce the final water content to a proportion of from 2% to 10% (e.g., 3%, 4%, 5%, 6%, 7%, 8% or 9%). This water content is helpful for ensuring the desired product properties, such as crispiness, but also shelf life.

Characterizing properties of dried products according to the invention can—apart from human sensory methods—be described by machine-based texture analysis. For example, the Liu method (Liu, Chenghai; Zheng, Xianzhe; Shi, John; Xue, Jun; Lan, Yubin; Jia, Shuhua (2010): Optimising micro-wave vacuum puffing for bluehoneysuckle snacks. In: Food Science and Technology 45, pages 506-511) makes it possible to test for the parameters breaking force and crispiness.

The crispiness of the dried products according to the invention is defined according to the Liu method as the number of significant fractures in a first positive bite region. In a force-time chart, crispiness can be expressed according to said method as the number of peaks which precede a maximum peak, which in turn can represent the complete fracture of a dried product at the end of a first positive bite region. The height of the individual peaks has an influence too on the sensory experience of crispiness. In the case of very low peaks, it is possible to perceive more a quiet crispy noise before the fracture of the sample; high peaks bring about a louder noise and a higher level of crispiness.

In the case of the dried products according to the invention, there was found to be a dependence of the observed crispiness on the water content before the microwave drying (puffing), the conditions during the microwave drying (puffing) (e.g., duration, pressure, temperature or microwave intensity).

In various measurement series, peach, apple, pineapple, kiwifruit, melon (galia), strawberry and banana were used as base fruits. These were processed in pure form or combined with a wide variety of different fruits as a mixture or in an arrangement in layers. These include mango, forest fruit mixture, raspberry, coconut. Likewise, the antioxidative action and effect on texture was tested by spraying on a wide variety of different highly acidic fruit juices.

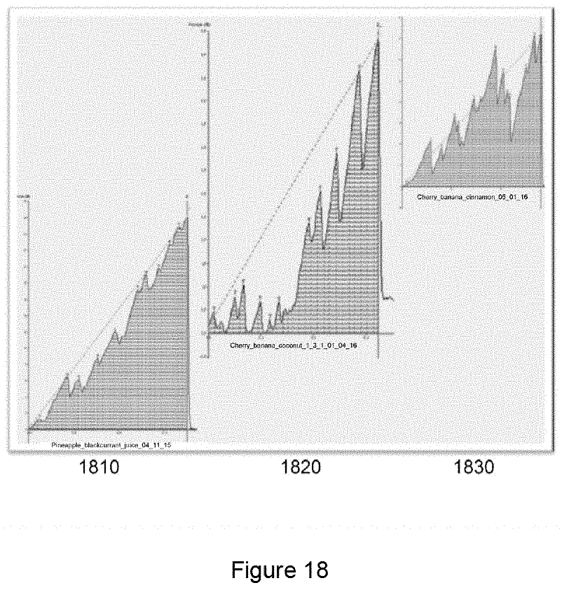

FIG. 18 shows exemplary texture analyses based on the Liu method for three dried products according to the invention. Here, the breaking force is the maximally applied force for breaking a snack. In the charts in FIG. 18, this is the maximum peak. Crispiness is determined in the charts in FIG. 18 by the linear distance toward the maximum peak. Here, the number of peaks also appears to be of significance. The more peaks, the more air pockets present in the product and the looser and crispier the product. In the case of the dried products according to the invention, between 5 and 20 peaks were observed in exemplary measurements, which peaks precede the maximum peak in a first positive bite region. A pleasing crispiness was observed especially in the case of numbers of from 7 to 15 peaks (e.g., 8, 9, 10, 11, 12, 13 or 14 peaks) before the maximum peak. A pleasing crispiness further became apparent for the dried products according to the invention when, in the case of at least 3 peaks before the maximum peak or the fracture, the peak height of the individual peaks is more than 5% of the total peak height, preferably more than 10%, particularly advantageously more than 20%. In the case of a texture designed in this way, the crunching of the products by the persons of a panel is described as particularly crispy, since multiple distinctly audible individual fractures are perceivable before the total fracture. Chart 1810 shows the measurement of a dried product according to the invention made from pineapple mixed with juice from blackcurrant, with about peaks being observed on average before the maximum peak. Chart 1820 shows the measurement of a dried product according to the invention made from cherry, banana and coconut, with about 10 peaks being observed on average before the maximum peak. Chart 1830 shows the measurement of a dried product according to the invention made from cherry, banana and cinnamon, with up to 10 peaks being observed on average before the maximum peak.

Fundamentally, there was found to be a strong influence of the raw material used, or of the comminuted constituents of that fruit variety used as a base. For example, an advantageous texture arises when using puréed pineapple or puréed banana as a base. The texture properties were more favorable in the case of banana that had been stored; in the case of pineapple, fresher fruits were also better suitable with regard to the texture of the dried product. Whereas the banana purées have a very good foamy texture after the microwave drying (puffing), the pineapple products are less foamy or more subtly foamy and have nevertheless a pore structure and thus likewise a very good crispiness. Furthermore, it became apparent that, for example, the addition of coconut makes it possible to generate more crumbly dried products, i.e., a mouthfeel similar to that of a piece of shortcrust pastry.

A homogeneous, crispy texture is characteristic of the dried products according to the invention when using pure or mixed and finely comminuted purées as raw material as described herein.

### EXAMPLES

### Exemplary Embodiment 1

25 g of strawberry purée are added to 100 g of freshly puréed banana mash and the two masses are well blended. After the mixture has been predried in an oven at 80° C. to a residual water content of 40%, small cubes having an edge length of 1 cm are shaped from the mass and they are brought to 15% residual moisture in a closed chamber at 100 mbar pressure by means of microwaves and then dried to <7% moisture in a vacuum oven (60° C.). In a sensory test, the cubes exhibit a balanced sweetness and acidity, an appealing reddish color and a crispy texture.

### Exemplary Embodiment 2

Fresh pineapple which had not been temporarily stored was peeled and 1 kg of the peeled fruits was comminuted using a cutting mill. The puréed pineapple was applied to a baking tray and uniformily distributed to form a thickness of the mass of about 10 mm. In an oven, the mass was predried at 70° C. up to a content of dried substance of 50%. The dried mass was then cut into strips 10-12 mm wide and placed in a vacuum microwave oven and heated at 40° C. for 5 minutes, and postdried at 60° C. for 5 hours at 20 mbar pressure. Thereafter, the fruit pieces had a crispy texture and generated a pleasing crispy noise upon consumption. With respect to the sensory assessment, it became apparent that, with a relatively long comminution, it is possible to achieve a better assessment by a trained sensory panel with respect to naturalness of the color and acceptance of the appearance. With respect to the duration of storage, it was found that the panel gave a better assessment for the fresh pineapples with respect to color and appearance than for pineapples stored for 2 weeks.

### Exemplary Embodiment 3

Bananas stored for 2 weeks were peeled and a quantity of 1 kg was comminuted using a cutting mill and processed under the same conditions as in the above example to yield expanded, crispy strips. With respect to the sensory assessment, it became apparent that the panel gave a distinctly better assessment, with respect to flavor, taste, crispiness and volume of the dried products, for the expanded bananas stored for 2 weeks and already exhibiting brown spots on the skin than for the dried products obtained from fresh bananas.

### Exemplary Embodiment 4

The following dried products according to the invention were given a particularly positive assessment in human sensory tests:

Dried product 1 made from banana and 14% acerola juice, dried product 2 made from banana and 14% grapefruit juice, dried product 3 made from banana and 14% sea buckthorn juice, dried product 4 made from banana and 14% blackcurrant juice, dried product 5 made from pineapple and 14% acerola juice, dried product 6 made from pineapple and 14% grapefruit juice, dried product 7 made from pineapple and 14% sea buckthorn juice, dried product 8 made from pineapple and 14% blackcurrant juice, dried product 9 made from banana and 18% acerola juice, dried product 10 made from 25% fresh coconut and 75% banana, dried product 11 made from 15% coconut and 85% banana, dried product 12 made from 33.33% raspberry and 66.66% banana (layered), dried product 13 made from 75% banana and 25% mango (layered), dried product 14 made from 25% banana and 75% mango (mixed) and dried product 15 made from 50% pineapple (evaporated to a dried substance of 80%) and 50% strawberry (evaporated to a dried substance of 80%), then whirled or marbled and predried.

### Exemplary Embodiment 5

Selected dried products according to the invention were subjected to an experimental determination of pore size by means of mercury porosimetry.

A QUANTACHROME POREMASTER 60-GT is used for the pore analysis by means of mercury porosimetry. The basis of the method is the so-called Washburn's equation, which describes the dependence of the pore diameter to be filled (intrusion) or to be emptied (extrusion) on the applied pressure for a nonwetting liquid (mercury).

With the POREMASTER 60-GT, the measurement cells are filled before the actual measurement in a horizontal position: this prevents a static pressure of the heavy mercury (density about 13.5 g/cm3) on the sample and an undetected filling of large pores.

The measurement results are depicted as intruded volume against the pressure or against the pore diameter. Since, in mercury porosimetry, the large pores are filled first at small pressures, it is standard to find on the corresponding x-axes the large pores on the left and the small pores on the right.

The samples were not dried further, but measured in the initial state. For weighing, a relatively large sample amount was used in each case (about 0.5 to just under 1 gram).

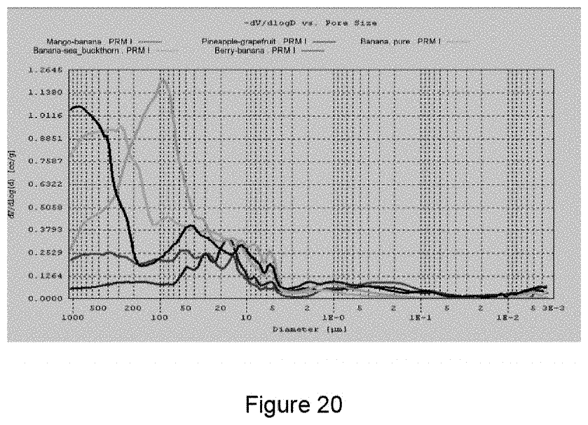

FIGS. 19 and 20 show two ways of depicting the results graphically:

In the case of a curve of the normalized volume (FIG. 19), the intruded mercury volume is plotted against the pore diameter.

The pore size distribution curve (FIG. 20) is calculated by differentiation from the curve of the normalized volume.

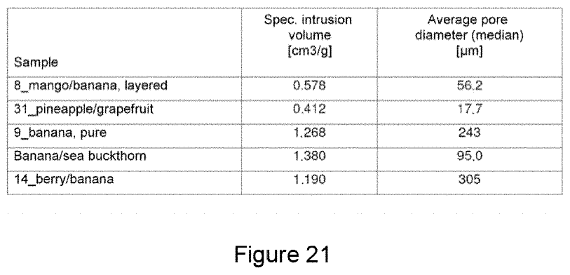

With this method, inaccuracies may arise owing to relatively large air pockets or other cavities which are above the measurement range of the method (greater than 1 mm) and are therefore not registered at all. The samples may have roughnesses and other surface structures which are in some cases within the measurement range of the method and are therefore registered as well, without a distinction relative to “genuine pores” being possible. Nevertheless, the table of FIG. 21 provides an estimate for an average pore diameter of dried products according to the invention made from comminuted constituents of at least one fruit variety.

1.-162. (canceled)

163. A method of manufacturing a dried fruit product, the method comprising:
providing constituents of at least one fruit variety;
comminuting the constituents of the at least one fruit variety to form a moist mass, the moist mass comprising a consistency of a puree;
predrying the moist mass to produce a predried mass, wherein a water content of the predried mass is reduced to a proportion of mass from about 35% to about 60% of an original water content of the moist mass;
inputting an inert gas into the predried mass to produce a foamed up predried mass; and
microwave drying the foamed up predried mass under reduced pressure conditions to produce the dried fruit product.

164. The method of claim 163, wherein comminuting the constituents of the at least one fruit variety to form the moist mass results in less than 90% of cells of the constituents of the at least one fruit variety being intact.

165. The method of claim 163, wherein microwave drying the foamed up predried mass under reduced pressure results in the dried fruit product comprising a volume at least 150% more than a volume of the predried mass.

166. The method of claim 163, wherein microwave drying the foamed up predried mass under reduced pressure results in the dried fruit product comprising a lightness value in an L*a*b* color space with a standard deviation less than 10.

167. The method of claim 163, wherein microwave drying the foamed up predried mass under reduced pressure results in the dried fruit product comprising a crispy texture, the crispy texture being defined by a force-time chart having at least five peaks, wherein at least three peaks of the at least five peaks have a peak height of at least 5% of a height of a maximum peak of the at least five peaks.

168. The method of claim 163, wherein microwave drying the foamed up predried mass under reduced pressure results in the dried fruit product comprising an average pore diameter of about 15 micrometers to about 400 micrometers.

169. The method of claim 163, wherein providing constituents of the at least one fruit variety comprises providing one or more of pineapple, chokeberry, banana, date, strawberry, goji berry, raspberry, blueberry, blackberry, kiwifruit, melon, fig, peach, apricot, grape, physalis, currant, grapefruit, orange, lime, lemon, coconut, pear, acerola, mandarin, cherimoya, dragon fruit, pomegranate, guava, rosehip, cherry, lychee, mango, passion fruit, mirabelle, plum, cranberry, sea buckthorn, quince, gooseberry, acai, elderberry, and papaya lucuma.

170. The method of claim 163, further comprising:
providing constituents of at least one vegetable material; and
comminuting the constituents of the at least one fruit variety and the constituents of the at least one vegetable material to form the moist mass.

171. The method of claim 170, wherein providing constituents of the at least one vegetable material comprises providing one or more of avocado, pumpkin, carrot, tomato, zucchini, onion, garlic, curcuma, beetroot, potato, pepper, spinach, corn, artichoke, eggplant, cucumber, radish, leek, yam, cauliflower, broccoli, red cabbage, white cabbage, snap peas, fresh peas, beans, fennel, ginger, kohlrabi, parsnips, rhubarb, Brussel sprout, black salsify, celery, Chinese cabbage, mache, rocket, chard, chicory, kale, lettuce, iceberg lettuce, maca, sprouts, mushrooms, chili peppers, and olives.

172. The method of claim 163, further comprising mixing at least one spice to the moist mass.

173. The method of claim 172, wherein mixing the at least one spice to the moist mass comprises mixing one or more of parsley, basil, chives, dill, oregano, rosemary, marjoram, lovage, sage, ramson, savory, borage, stinging nettle, tarragon, chervil, coriander, mint, and woodruff to the moist mass.

174. The method of claim 163, further comprising mixing at least one seed to the moist mass.

175. The method of claim 174, wherein mixing the at least one seed to the moist mass comprises mixing one or more of linseeds, chia seeds, hempseeds, psyllium seeds, sunflower seeds, poppy seeds, pumpkin seeds, pine kernels, cumin seeds, fennel seeds, aniseeds, fenugreek seeds, and mustard seeds to the moist mass.
